(19) United States
(12) Patent Application Publication
(10) Pub. No.: US 2024/0303486 A1
(43) Pub. Date: Sep. 12, 2024

(54) Collaborative Online Model Adaptation For Resource Constraint Devices

(71) Applicant: Nokia Technnologies Oy, Espoo (FI)

(72) Inventors: Hamed Rezazadegan Tavakoli, Espoo (FI); Amirhossein Hassankhani, Tampere (FI); Esa Rahtu, Pirkkala (FI)

(21) Appl. No.: 18/581,593

(22) Filed: Feb. 20, 2024

Related U.S. Application Data
(60) Provisional application No. 63/450,703, filed on Mar. 8, 2023.

(51) Int. Cl. G06N 3/08

(52) U.S. Cl. CPC G06N 3/08

(57) ABSTRACT

An apparatus may be configured to: process at least one input with an efficient neural network; determine at least one performance criteria for the efficient neural network; and activate online learning for the efficient neural network based, at least partially, on the at least one performance criteria. An apparatus may be configured to: receive, from an efficient neural network, at least one video frame or at least one feature; determine at least one inference result based, at least partially, on the at least one video frame or the at least one feature; and transmit, to the efficient neural network, the at least one inference result.

### PRIORITY BENEFIT

This application claims priority under 35 U.S.C. 119(e) (1) to U.S. Provisional Patent Application No. 63/450,703, filed Mar. 8, 2023, which is hereby incorporated by reference in its entirety.

### BACKGROUND

It is known, in neural network systems, to perform collaborative inference.

### FIELD OF EMBODIMENTS

The example and non-limiting embodiments relate generally to neural networks and, more particularly, to on device learning.

### BRIEF SUMMARY OF EMBODIMENTS

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: process at least one input with an efficient neural network; determine at least one performance criteria for the efficient neural network; and activate online learning for the efficient neural network based, at least partially, on the at least one performance criteria.

In accordance with one aspect, a method comprising: processing, with a user equipment, at least one input with an efficient neural network; determining at least one performance criteria for the efficient neural network; and activating online learning for the efficient neural network based, at least partially, on the at least one performance criteria.

In accordance with one aspect, an apparatus comprising means for performing: processing at least one input with an efficient neural network; determining at least one performance criteria for the efficient neural network; and activating online learning for the efficient neural network based, at least partially, on the at least one performance criteria.

In accordance with one aspect, a non-transitory computer-readable medium comprising program instructions stored thereon for performing at least the following: processing at least one input with an efficient neural network; determining at least one performance criteria for the efficient neural network; and activating online learning for the efficient neural network based, at least partially, on the at least one performance criteria.

In accordance with one aspect, an apparatus comprising: at least one processor; and at least one memory storing instructions that, when executed by the at least one processor, cause the apparatus at least to: receive, from an efficient neural network, at least one video frame or at least one feature; determine at least one inference result based, at least partially, on the at least one video frame or the at least one feature; and transmit, to the efficient neural network, the at least one inference result.

In accordance with one aspect, a method comprising: receiving, from an efficient neural network, at least one video frame or at least one feature; determining at least one inference result based, at least partially, on the at least one video frame or the at least one feature; and transmitting, to the efficient neural network, the at least one inference result.

In accordance with one aspect, an apparatus comprising means for performing: receiving, from an efficient neural network, at least one video frame or at least one feature; determining at least one inference result based, at least partially, on the at least one video frame or the at least one feature; and transmitting, to the efficient neural network, the at least one inference result.

In accordance with one aspect, a non-transitory computer-readable medium comprising program instructions stored thereon for performing at least the following: causing receiving, from an efficient neural network, of at least one video frame or at least one feature; determining at least one inference result based, at least partially, on the at least one video frame or the at least one feature; and causing transmitting, to the efficient neural network, of the at least one inference result.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a block diagram of one possible and non-limiting exemplary system in which the example embodiments may be practiced;

FIG. 3 is a diagram illustrating features as described herein;

FIG. 4 is a diagram illustrating features as described herein;

FIG. 5 is a diagram illustrating features as described herein;

FIG. 6 is a diagram illustrating features as described herein;

FIG. 7 is a diagram illustrating features as described herein;

FIG. 8 is a diagram illustrating features as described herein;

FIG. 9 is a diagram illustrating features as described herein;

FIG. 10 is a diagram illustrating features as described herein;

FIG. 11 is a diagram illustrating features as described herein;

FIG. 12 is a flowchart illustrating steps as described herein; and

FIG. 13 is a flowchart illustrating steps as described herein.

### DETAILED DESCRIPTION OF EMBODIMENTS

The following abbreviations that may be found in the specification and/or the drawing figures are defined as follows:
3GPP third generation partnership project
4G fourth generation
5G fifth generation
5GC 5G core network
6G sixth generation
AR augmented reality
CDMA code division multiple access
CPU central processing unit
cRAN cloud radio access network
DSP digital signal processor
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
ENN efficient neural network
E-UTRA evolved universal terrestrial radio access, i.e., the LTE radio access technology
FDMA frequency division multiple access
gNB (or gNodeB) base station for 5G/NR, i.e., a node providing NR user plane and control plane protocol terminations towards the UE, and connected via the NG interface to the 5GC
GNN generic neural network
GPU graphical processing unit
GSM global systems for mobile communications
HEVC high efficiency video coding
HMD head-mounted display
IEEE Institute of Electrical and Electronics Engineers
IMD integrated messaging device
IMS instant messaging service
IoT Internet of Things
JPEG joint photographic experts group
JPEG-AI joint photographic experts group-artificial intelligence
LTE long term evolution
MMS multimedia messaging service
MPEG-I Moving Picture Experts Group immersive codec family
MR mixed reality
MSE mean squared error
ng or NG new generation
ng-eNB or NG-eNB new generation eNB
NN neural network
NNC neural network compression
NR new radio
N/W or NW network
O-RAN open radio access network
PC personal computer
PDA personal digital assistant
SMS short messaging service
TCP-IP transmission control protocol-internet protocol
TDMA time division multiple access
UE user equipment (e.g., a wireless, typically mobile device)
UMTS universal mobile telecommunications system
USB universal serial bus
VCM video coding for machines
VNR virtualized network function
VR virtual reality
VVC versatile video coding
WLAN wireless local area network

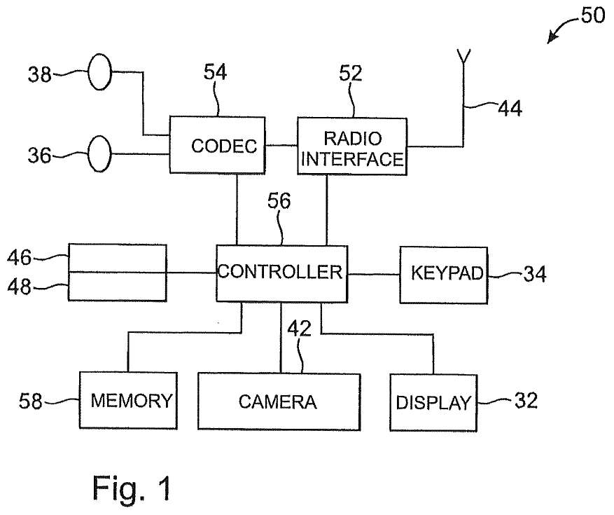

The following describes suitable apparatus and possible mechanisms for practicing example embodiments of the present disclosure. Accordingly, reference is first made to FIG. 1, which shows an example block diagram of an apparatus 50. The apparatus may be configured to perform various functions such as, for example, gathering information by one or more sensors, encoding and/or decoding information, receiving and/or transmitting information, analyzing information gathered or received by the apparatus, or the like. A device configured to encode a video scene may (optionally) comprise one or more microphones for capturing the scene and/or one or more sensors, such as cameras, for capturing information about the physical environment in which the scene is captured. Alternatively, a device configured to encode a video scene may be configured to receive information about an environment in which a scene is captured and/or a simulated environment. A device configured to decode and/or render the video scene may be configured to receive a Moving Picture Experts Group immersive codec family (MPEG-I) bitstream comprising the encoded video scene. A device configured to decode and/or render the video scene may comprise one or more speakers/audio transducers and/or displays, and/or may be configured to transmit a decoded scene or signals to a device comprising one or more speakers/audio transducers and/or displays. A device configured to decode and/or render the video scene may comprise a user equipment, a head/mounted display, or another device capable of rendering to a user an AR, VR and/or MR experience.

The electronic device 50 may for example be a mobile terminal or user equipment of a wireless communication system. Alternatively, the electronic device may be a computer or part of a computer that is not mobile. It should be appreciated that example embodiments may be implemented within any electronic device or apparatus which may process data. The electronic device 50 may comprise a device that can access a network and/or cloud through a wired or wireless connection. The electronic device 50 may comprise one or more processors 56, one or more memories 58, and one or more transceivers 52 interconnected through one or more buses. The one or more processors 56 may comprise a central processing unit (CPU) and/or a graphical processing unit (GPU). Each of the one or more transceivers 52 includes a receiver and a transmitter. The one or more buses may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers may be connected to one or more antennas 44. The one or more memories 58 may include computer program code. The one or more memories 58 and the computer program code may be configured to, with the one or more processors 56, cause the electronic device 50 to perform one or more of the operations as described herein.

The electronic device 50 may connect to a node of a network. The network node may comprise one or more processors, one or more memories, and one or more transceivers interconnected through one or more buses. Each of the one or more transceivers includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers may be connected to one or more antennas. The one or more memories may include computer program code. The one or more memories and the computer program code may be configured to, with the one or more processors, cause the network node to perform one or more of the operations as described herein.

The electronic device 50 may comprise a microphone 36 or any suitable audio input which may be a digital or analogue signal input. The electronic device 50 may further comprise an audio output device 38 which in example embodiments may be any one of: an earpiece, speaker, or an analogue audio or digital audio output connection. The electronic device 50 may also comprise a battery (or in other example embodiments the device may be powered by any suitable mobile energy device such as solar cell, fuel cell, or clockwork generator). The electronic device 50 may further comprise a camera 42 or other sensor capable of recording or capturing images and/or video. Additionally or alternatively, the electronic device 50 may further comprise a depth sensor. The electronic device 50 may further comprise a display 32. The electronic device 50 may further comprise an infrared port for short range line of sight communication to other devices. In other example embodiments the apparatus 50 may further comprise any suitable short-range communication solution such as for example a BLUETOOTH™ wireless connection or a USB/firewire wired connection.

It should be understood that an electronic device 50 configured to perform example embodiments of the present disclosure may have fewer and/or additional components, which may correspond to what processes the electronic device 50 is configured to perform. For example, an apparatus configured to encode a video might not comprise a speaker or audio transducer and may comprise a microphone, while an apparatus configured to render the decoded video might not comprise a microphone and may comprise a speaker or audio transducer.

Referring now to FIG. 1, the electronic device 50 may comprise a controller 56, processor or processor circuitry for controlling the apparatus 50. The controller 56 may be connected to memory 58 which in example embodiments may store both data in the form of image and audio data and/or may also store instructions for implementation on the controller 56. The controller 56 may further be connected to codec circuitry 54 suitable for carrying out coding and/or decoding of audio and/or video data or assisting in coding and/or decoding carried out by the controller.

The electronic device 50 may further comprise a card reader 48 and a smart card 46, for example a UICC and UICC reader, for providing user information and being suitable for providing authentication information for authentication and authorization of the user/electronic device 50 at a network. The electronic device 50 may further comprise an input device 34, such as a keypad, one or more input buttons, or a touch screen input device, for providing information to the controller 56.

The electronic device 50 may comprise radio interface circuitry 52 connected to the controller and suitable for generating wireless communication signals for example for communication with a cellular communications network, a wireless communications system, or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The electronic device 50 may comprise a microphone 38, camera 42, and/or other sensors capable of recording or detecting audio signals, image/video signals, and/or other information about the local/virtual environment, which are then passed to the codec 54 or the controller 56 for processing. The electronic device 50 may receive the audio/image/video signals and/or information about the local/virtual environment for processing from another device prior to transmission and/or storage. The electronic device 50 may also receive either wirelessly or by a wired connection the audio/image/video signals and/or information about the local/virtual environment for encoding/decoding. The structural elements of electronic device 50 described above represent examples of means for performing a corresponding function.

The memory 58 may be of any type suitable to the local technical environment and may be implemented using any suitable data storage technology, such as semiconductor-based memory devices, flash memory, magnetic memory devices and systems, optical memory devices and systems, fixed memory and removable memory. The memory 58 may be a non-transitory memory. The memory 58 may be means for performing storage functions. The controller 56 may be or comprise one or more processors, which may be of any type suitable to the local technical environment, and may include one or more of general-purpose computers, special purpose computers, microprocessors, digital signal processors (DSPs) and processors based on a multi-core processor architecture, as non-limiting examples. The controller 56 may be means for performing functions.

The electronic device 50 may be configured to perform capture of a volumetric scene according to example embodiments of the present disclosure. For example, the electronic device 50 may comprise one or more cameras 42 or one or more other sensors capable of recording or capturing images and/or video. The electronic device 50 may also comprise one or more transceivers 52 to enable transmission of captured content for processing at another device. Such an electronic device 50 may or may not include all the modules illustrated in FIG. 1.

The electronic device 50 may be configured to perform processing of volumetric video content according to example embodiments of the present disclosure. For example, the electronic device 50 may comprise a controller 56 for processing images to produce volumetric video content, a controller 56 for processing volumetric video content to project 3D information into 2D information, patches, and auxiliary information, and/or a codec 54 for encoding 2D information, patches, and auxiliary information into a bitstream for transmission to another device with radio interface 52. Such an electronic device 50 may or may not include all the modules illustrated in FIG. 1.

The electronic device 50 may be configured to perform encoding or decoding of 2D information representative of volumetric video content according to example embodiments of the present disclosure. For example, the electronic device 50 may comprise a codec 54 for encoding or decoding 2D information representative of volumetric video content. Such an electronic device 50 may or may not include all the modules illustrated in FIG. 1.

The electronic device 50 may be configured to perform rendering of decoded 3D volumetric video according to example embodiments of the present disclosure. For example, the electronic device 50 may comprise a controller for projecting 2D information to reconstruct 3D volumetric video, and/or a display 32 for rendering decoded 3D volumetric video. Such an electronic device 50 may or may not include all the modules illustrated in FIG. 1.

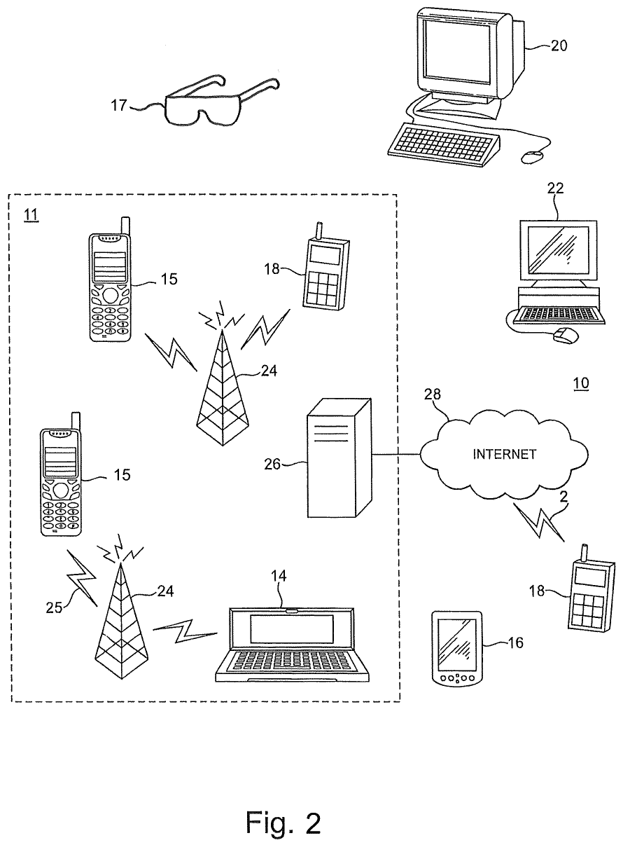

With respect to FIG. 2, an example of a system within which example embodiments of the present disclosure can be utilized is shown. The system 10 comprises multiple communication devices which can communicate through one or more networks. The system 10 may comprise any combination of wired or wireless networks including, but not limited to a wireless cellular telephone network (such as a GSM, UMTS, E-UTRA, LTE, CDMA, 4G, 5G, 5G-Advanced, 6G network etc.), a wireless local area network (WLAN) such as defined by any of the IEEE 802.x standards, a BLUETOOTH™ personal area network, an Ethernet local area network, a token ring local area network, a wide area network, and/or the Internet. A wireless network may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors and memories, and also such virtualized entities create technical effects.

It may also be noted that operations of example embodiments of the present disclosure may be carried out by a plurality of cooperating devices (e.g. cRAN).

The system 10 may include both wired and wireless communication devices and/or electronic devices suitable for implementing example embodiments.

For example, the system shown in FIG. 2 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an apparatus 15, a combination of a personal digital assistant (PDA) and a mobile telephone 14, a PDA 16, an integrated messaging device (IMD) 18, a desktop computer 20, a notebook computer 22, and a head-mounted display (HMD) 17. The electronic device 50 may comprise any of those example communication devices. In an example embodiment of the present disclosure, more than one of these devices, or a plurality of one or more of these devices, may perform the disclosed process(es). These devices may connect to the internet 28 through a wireless connection 2.

The example embodiments may also be implemented in a set-top box; i.e. a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding. The example embodiments may also be implemented in cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Some or further apparatus may send and receive calls and messages and communicate with service providers through a wireless connection 25 to a base station 24, which may be, for example, an eNB, gNB, access point, access node, other node, etc. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), BLUETOOTHM, IEEE 802.11, 3GPP Narrowband IoT and any similar wireless communication technology. A communications device involved in implementing various example embodiments of the present disclosure may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, which may be a MPEG-I bitstream, from one or several senders (or transmitters) to one or several receivers.

Having thus introduced one suitable but non-limiting technical context for the practice of the example embodiments of the present disclosure, example embodiments will now be described with greater specificity.

Features as described herein generally relate to neural network compression (NNC) and video coding for machines (VCM) for MPEG.

Features as described herein may relate to semantic segmentation for environment sensing (i.e. scene understanding) and 3D reconstruction.

Features as described herein may relate to collaborative robust inference and performance of on device learning of neural networks in a resource constraint device.

A neural network (NN) is a computation graph consisting of two or more layers of computation. Each layer may consist of one or more units, where each unit may perform an elementary computation. A unit may be connected to one or more other units, and the connection may have a weight associated with it. The weight may be used for scaling the signal passing through the associated connection. Weights may be learnable parameters, i.e., values which can be learned from training data. There may be other learnable parameters, such as those of batch-normalization layers.

Two of the most widely used architectures for neural networks are feed-forward and recurrent architectures. Feed-forward neural networks do not comprise a feedback loop; each layer takes input from one or more of the previous layers and provides output, which is used as the input for one or more of the subsequent layers. Units within a layer take input from unit(s) in one or more preceding layers, and provide output to unit(s) of one or more following layers.

Initial layers, i.e. layers close to the input data, extract semantically low-level features from received data, and intermediate and final layers extract more high-level features. After the feature extraction layers there may be one or more layers performing a certain task, such as classification, semantic segmentation, object detection, denoising, style transfer, super-resolution, etc. In recurrent neural networks, there is a feedback loop, so that the network becomes stateful, i.e., it is able to memorize or retain information or a state.

Neural networks may be utilized in an ever increasing number of applications for many different types of device, such as mobile phones, as described above. Examples of applications may include image and video analysis and processing, social media data analysis, device usage data analysis, etc.

Neural networks, and other machine learning tools, may be able to learn properties from input data, either in a supervised way or in an unsupervised way. Such learning may be the result of a training algorithm, or of a meta-level neural network providing a training signal,

A training algorithm may consist of changing some properties of the neural network so that the output of the neural network is as close as possible to a desired output. Training may comprise changing properties of the neural network so as to minimize or decrease the output's error, also referred to as the loss. Examples of losses include mean squared error (MSE), cross-entropy, etc. In recent deep learning techniques, training is an iterative process, where, at each iteration, the algorithm modifies the weights of the neural network to make a gradual improvement of the network's output, i.e., to gradually decrease the loss.

Training a neural network comprises an optimization process, but the final goal of machine learning is different from the typical goal of optimization. In optimization, the goal is to minimize loss. In machine learning generally, in addition to the goal of optimization, the goal is to make the model learn the properties of the data distribution from a limited training dataset. In other words, the training process is additionally used to ensure that the neural network learns to use a limited training dataset in order to learn to generalize to previously unseen data, i.e., data which was not used for training the model. This additional goal is usually referred to as generalization. In practice, data may be split into at least two sets, the training set and the validation set. The training set may be used for training the network, i.e., for modification of its learnable parameters in order to minimize the loss. The validation set may be used for checking the performance of the neural network with data which was not used to minimize the loss (i.e. which was not part of the training set), where the performance of the neural network with the validation set may be an indication of the final performance of the model. The errors on the training set and on the validation set may be monitored during the training process to understand if the neural network is learning at all and if the neural network is learning to generalize. In the case that the network is learning at all, the training set error should decrease. If the network is not learning, the model may be in the regime of underfitting. In the case that the network is learning to generalize, validation set error should decrease and not be much higher than the training set error. If the training set error is low, but the validation set error is much higher than the training set error, or the validation set error does not decrease, or it even increases, the model may be in the regime of overfitting. Overfitting may mean that the model has memorized the training set's properties and performs well only on that set, but performs poorly on a set not used for tuning its parameters. In other words, the model has not learned to generalize.

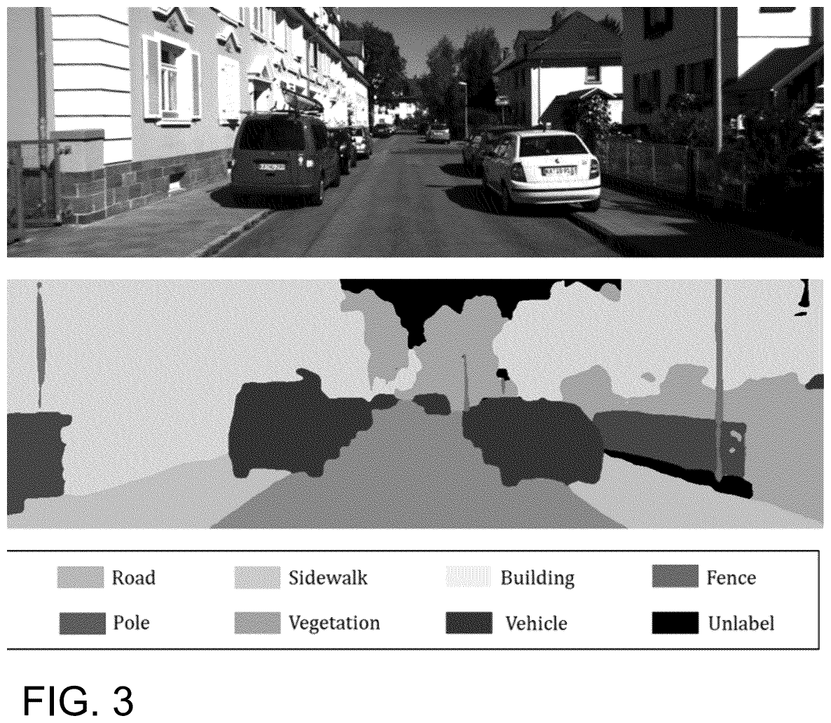

In environment sensing and scene understanding, semantic segmentation is one critical task. Semantic segmentation assigns a class to each pixel in an image. This can be very useful, in many applications like self-driving cars, in understanding the environment in 3D modelling and alike applications. For on device semantic segmentation in videos, the following challenges exist: low temporal consistency; and heavy computation during online learning. Online learning is training or learning of a NN during inference (which may not be common in NNs). Referring now to FIG. 3, illustrated is an example of semantic segmentation. The example input image 310 may be segmented, for example as shown at 320, into road, pole, sidewalk, vegetation, building, vehicle, fence, and unlabeled classes. These classifications are not limiting; the use of other classes is possible.

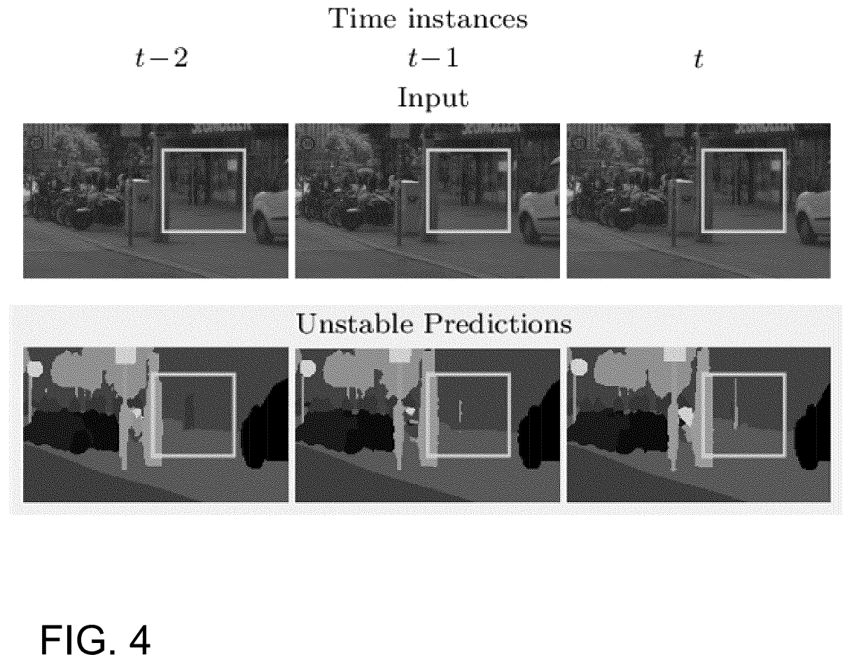

The issue of temporal consistency may arise in real-world applications where video is processed. For video-based semantic segmentation, the methods often are lacking consistency between the output of consecutive frames. That is, the output may have a flickering effect. For example, a pixel that is classified as a tree in one frame may appear/be classified as a wall in the next frame. Referring now to FIG. 4, illustrated is an example of the temporal consistency problem in video-based scene semantic segmentation. At time t−2, the portion of the input image may be classified with a first class that is here labeled with red (darkest portion inside white box). At time t−1, the spatially similar portion of the input image may be classified with a second class that is labeled with gray (lightest portion inside white box). At time t, the spatially similar portion of the input image may be classified with both the first class, labeled with red (darkest portion inside white box), and the second class, labeled with gray (lightest portion inside white box). In other words, the classification of the same pixels is varying across time instances.

This problem with temporal consistency is observed in both single-frame approaches that process video frames independent of each other, and multi-frame approaches that process dependency of frames by adding some more computation to the model.

The issue of heavy computation during online learning may arise where online and on device learning and regularization methods are used to enforce the temporal consistency. For a neural network based approach, this may mean that backpropagation is involved through a large network, which is computationally expensive and makes implementation for on-device applications almost impossible or impractical.

Collaborative inference is a paradigm that enables multiple entities to perform a task and achieve one objective together. Collaborative inference is a way of utilizing a collective knowledge of multiple (i.e. more than one) algorithms (e.g. neural networks) to perform a task better. Such a technique is also referred to as an ensemble-based technique. The ensemble technique is commonly known of multiple algorithms that are operating in the same machine. The ensembles are often trained once and utilized several times for the inference and decision making.

Online learning, also known as adaptive algorithms, learn and improve themselves from the environment feedback. They improve their performance over time. Major adaptive algorithms are rooted in the control theory, where often a closed loop system rectifies the error that it senses from its input; the inverted pendulum system is a famous example of a system that could be solved by an adaptive algorithm. The online adaptation for neural network based solution is, however, difficult for devices because of the limited computational capabilities and large size of neural networks. Using this paradigm for learning/teaching a neural network may also be called “naïve adapt”, in which the output of the system may be used to correct and retrain the neural network.

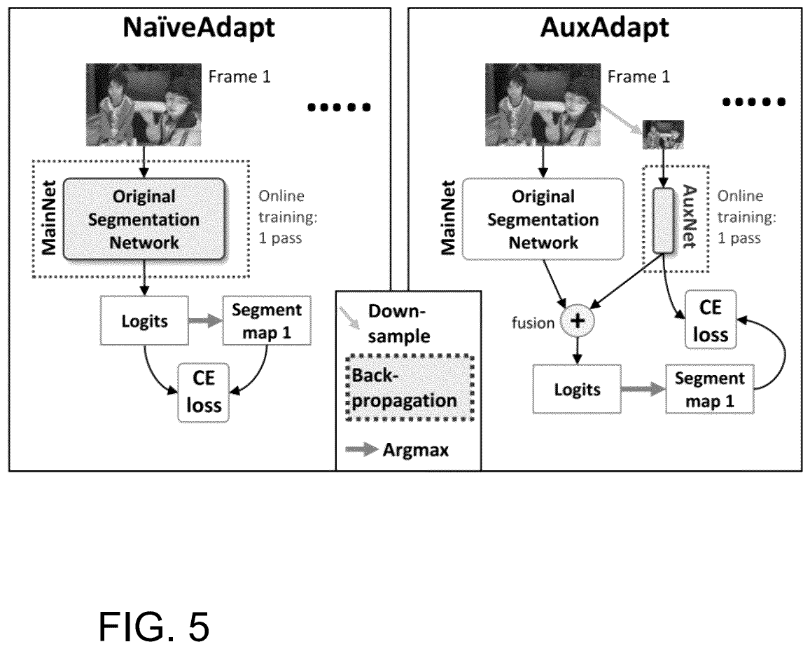

To address the challenge of temporally consistent semantic segmentation on devices, AuxAdapt introduces a new method for improving temporal consistency by incorporating a smaller network to enforce the joint prediction of previous frames in the smaller network, making the next predictions more consistent with previous ones (see Yizhe Zhang, Shubhankar Borse, Hong Cai, and Fatih Porikli. Auxadapt: Stable and efficient test-time adaptation for temporally consistent video semantic segmentation. In Proceedings of the IEEE/CVF Winter Conference on Applications of Computer Vision, 2022). The AuxAdapt is proposed to improve the NaiveAdapt approaches, which adapts one neural network. There are two advantage of using AuxAdapt instead of NaiveAdapt: 1) the heavy backpropagation is done for a much smaller network; and 2) by having a fixed/frozen network (MainNet), the output is more stable and doesn't collapse. Referring now to FIG. 5, illustrated is a comparison of NaiveAdapt and AuxAdapt.

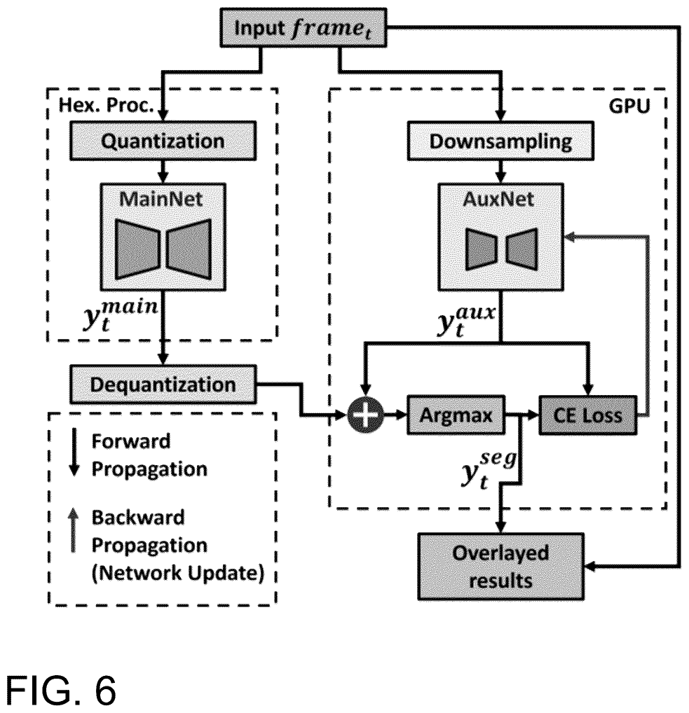

AuxAdapt could be implemented on mobile devices (see H. Park et al., “Real-Time, Accurate, and Consistent Video Semantic Segmentation via Unsupervised Adaptation and Cross-Unit Deployment on Mobile Device,” 2022 IEEE/CVF Conference on Computer Vision and Pattern Recognition (CVPR), New Orleans, LA, USA, 2022). In this implementation, a quantized version of MainNet is deployed on a digital signal processor (DSP) or simple mobile device, while the computation of the smaller network (AuxNet) is done in the GPU. Referring now to FIG. 6, illustrated is an example of an AuxAdapt implementation with DSP and GPU. Running an ensemble on a DSP and GPU all the time may still be computationally expensive, as the model is constantly adapted to the input data.

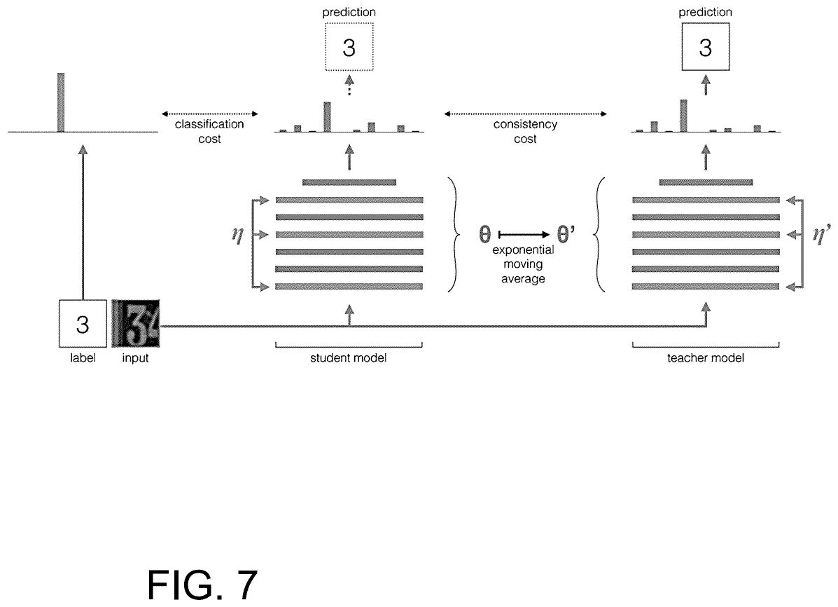

The “mean teacher” idea utilizes an exponential moving average to train one neural network for an image classification task (see Antti Tarvainen and Harri Valpola. Mean teachers are better role models: Weight-averaged consistency targets improve semi-supervised deep learning results. In NeurIPS, pages 1195-1204, 2017). In this scheme, a student network updates the weight of a teacher network during the training process. The training loss in this scheme is the difference between the teacher and student outputs. The intent of mean-teacher is proposing a novel algorithm for self-supervised neural network training in classification tasks. Referring now to FIG. 7, illustrated is an example of the mean-teacher paradigm.

In an example embodiment, a system and process for a collaborative inference scheme between a device and a cloud/network source may be implemented. In an example embodiment, a semantic segmentation scenario under that process flow may be implemented. A technical effect of example embodiments of the present disclosure may be to split the computational load between a cloud and the device, which may result in better on device efficiency.

In an example embodiment, an online learning technique may be implemented. A technical effect of example embodiments of the present disclosure may be to enhance temporal consistency of semantic segmentation. In an example embodiment, the proposed technique may further be implemented independently and as part of the proposed system for a collaborative inference scheme between a device and a cloud/network source.

In an example embodiment, a temporal consistency measure may be used to activate the online learning on demand. A technical effect of example embodiments of the present disclosure may be to prevent excess computation during computations.

In an example embodiment, the output of one network is used as the labels for training another network.

In an example embodiment, a process and system flow for collaborative inference to enhance online learning of on device neural-network based algorithms may be implemented. The overall process may consist of a generic neural network (GNN) and an efficient neural network (ENN).

A GNN is a neural network configured to perform a task, for example, semantic segmentation, object detection, object tracking, etc. The GNN may be quantized, mixed precision, or float, and may be deployed on a cloud or edge machine with sufficient capabilities (e.g. memory and GPU to run the model without any limitation).

An ENN is a neural network optimized for on device deployment. The ENN may be quantized, or lower precision float, or even completely float, or mixed precision. The ENN may be a model of a specialized architecture, for example, a model of a limited number of parameters to fit.

A GNN and ENN may share the same architecture. For example, they may be part of the same neural network model. In another configuration, GNN and ENN may have different architectures, and one of them may have a greater number of parameters than the other one. GNN and ENN may have similar parameter precision (e.g. both may be quantized). Alternatively GNN and ENN may have different parameter precision (e.g. GNN may be float and ENN may be quantized, or vice versa).

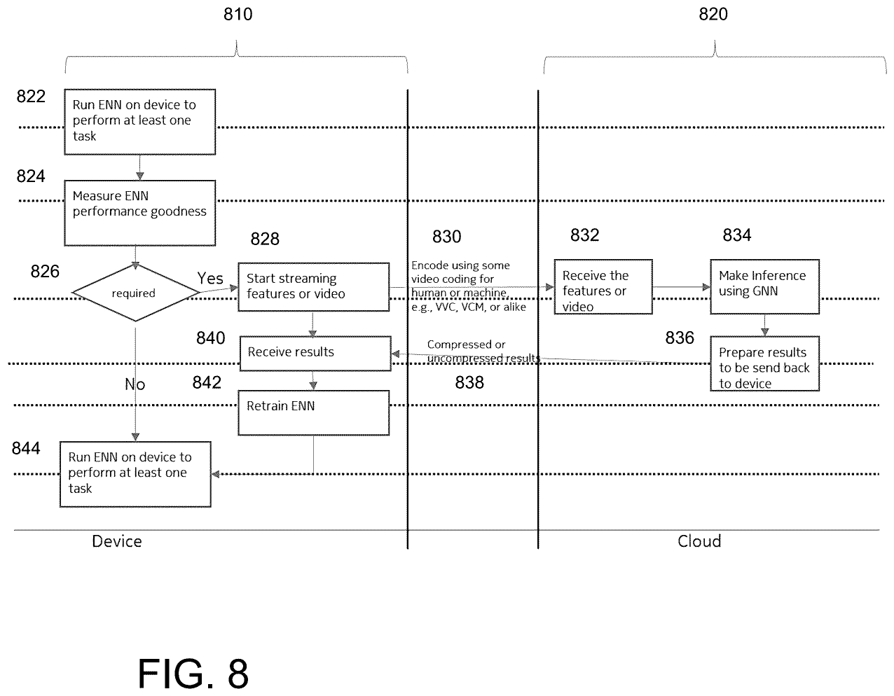

In an example embodiment, at least one ENN may be deployed on a device, and at least one GNN may be deployed on the cloud or edge. Referring now to FIG. 8, an example embodiment of a process to perform collaborative inference and online on device learning is illustrated. The device (810) starts processing the input for a task, for example, semantic segmentation. For example, at 822, the device (810) may run ENN to perform at least one task. At 824, the device (810) may measure ENN performance goodness (e.g. the goodness or fitness of the result/prediction of the ENN with respect to the task). For example, the device (810) may measure a metric of goodness to determine fitness of predictions (e.g. temporal consistency of segmented video frames). When the metric of goodness shows degradation in predictions of the ENN (e.g. the temporal consistency is lower than an expected value), at 826 the device (810) may determine to activate online learning (i.e. online learning may be required). The device (810) may communicate the video frame, or features from the video frame, to the cloud (820), where the video frames or features may have been compressed by some compression technique such as JPEG, HEVC, VVC or techniques that are suitable for machine consumption like VCM or JPEG-AT. The device (810) may save a copy of the frame temporally.

In the present disclosure, the terms “performance goodness”, “performance fitness”, “performance criteria”, “prediction goodness”, “prediction fitness”, and “prediction criteria” may be used interchangeably.

At 828, the device (810) may start streaming features or video to the cloud (820), At 830, the features or video may be encoded using some video coding for human or machine (e.g. versatile video coding (VVC), VCM, etc.). At 832, the cloud (820) may receive the features or video. At 834, the cloud (820) may make inference(s) using GNN. At 836, the cloud (820) may prepare results to be sent back to the device (810). At 838, the results may be compressed or uncompressed.

At 840, the device (810) may receive the results of the task (e.g., the segmentation maps) obtained by GNN from the server (e.g. cloud (820)). At 842, the device (810) may retrain the ENN based, at least partially, on the received results (e.g. from the server).

Online learning (e.g. 828-842) may be repeated as long as required.

At 844, when online learning is no longer required, the device (810) may run ENN to perform at least one task.

Else, if at 826 the device (810) determines to not activate online learning (i.e. not required), at 844 the device (810) may run ENN to perform at least one task.

In an alternative example embodiment, the training may also completely happen on the cloud (820), and a weight update may be communicated from the cloud (820) to the device (810), where the weight update may be compressed using a standard, such as neural network compression standard (e.g. NNC).

In an example embodiment, on device learning may be performed with momentum adapt. For example, the GNN/AuxNetwork and ENN/momentum network may have the same architecture. In an example embodiment, the GNN may be updated using the weights from the ENN. In other words, the GNN may be an exponential moving average of the ENN. For example:

$${θ}_{t}^{′} = {αθ}_{t - 1}^{′} + ( 1 - α ) {θ}_{t}$$

where α is a mixing factor, θ′ is the weights of the GNN, and θ is the weights of the ENN. The indices t and t−1 indicate the weights from time instances t and t−1.

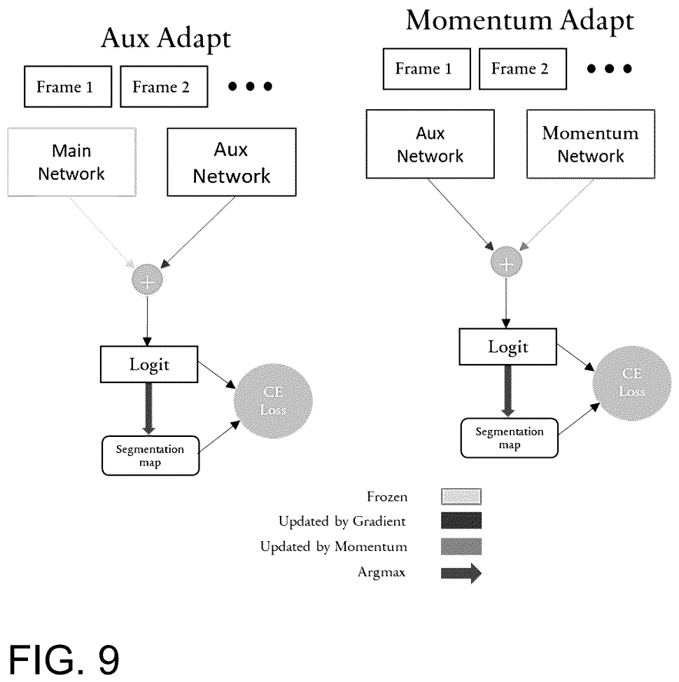

Referring now to FIG. 9, illustrated is a comparison between momentum adapt (920) and AuxAdapt (910). Momentum adapt may be different from AuxAdapt in that the MainNet (930) in AuxAdapt (910) is frozen (i.e. the weights are not updated during training and backpropagation), and is often of much larger capacity. That is, if AuxNet (910) may have 10M parameter(s), MainNet (930) may have 50M parameter(s). While the MainNet (930) is frozen, the aux network (932) may be updated by gradient. This may become a problem after some training because the main network (930) may become a liability for the aux network (932), and may feed temporally inaccurate predictions to the aux network (932).

In an example embodiment, in the example of momentum adapt (920), the momentum network (936) may not be kept frozen, and may (slowly) be moved towards the aux network (934). The aux network (934) may be updated by gradient, while the momentum network (936) may be updated by momentum. A technical effect of this example embodiment may be to achieve much better results with a much smaller neural network as Momentum Network (936), where Momentum Network (936) and AuxNet (934) are of same capacity, for example 10M parameter(s).

In another example embodiment, the GNN and ENN may be on the same location.

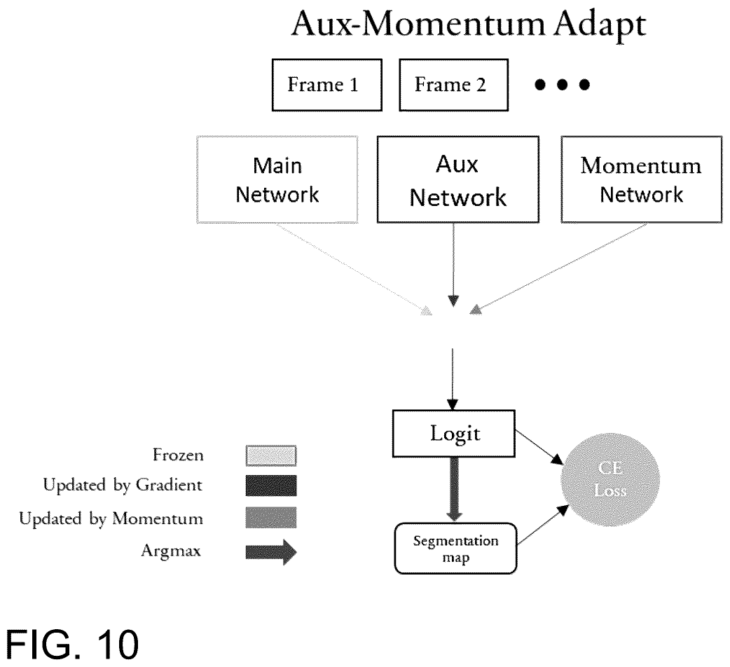

In an example embodiment, AuxAdapt and Momentum Adapt may be combined. In an example embodiment, one main network may be frozen, and two neural networks may be trained using momentum adapt scheme. Referring now to FIG. 10, illustrated is an example of an Aux-Momentum Adapt network. The Aux-Momentum Adapt network may include a main network (1010) that is frozen; an aux network (1020) that is updated by gradient; and a momentum network (1030) that is updated by momentum.

The difference between the Aux-Momentum Adapt network and the Aux Adapt network is that a momentum network (1030) is included instead of an auxnet. A technical effect of adding the momentum network (1030) may be to add the benefits of having a larger network (the main net (1010)) and, over time, better guidance by the momentum network (1030). The larger network may have 5 times the number of parameters of the momentum network, or more.

The difference between the Aux-Momentum Adapt network and the Momentum Adapt network is the adding of the main network (1010). A technical effect of adding the main network (1010) may be to enable better performance by incorporating a larger network.

In an example embodiment, the Main Network may be/function as the GNN, and both Aux Network and Momentum Network may be/function as ENN. In an alternative example embodiment, Main Network and AuxNetwork may be/function as GNN, and Momentum network may be/function as the ENN.

In an example embodiment, activation of adaptation on drift for semantic segmentation task may be performed. Adaptation may comprise re-training a NN model during inference time, and may be used as an alternative to online learning. In other words, a NN (either on a device or on a cloud, depending on the configuration) may undergo adaptation or online learning. Instead of running the adaptation all the time, in an example embodiment the adaptation may be activated when needed.

In an example embodiment, after an adaptation period, the adaptation may be disabled. In an example embodiment, temporal consistency may be measured, and when the temporal consistency drastically decreases, in comparison to the average temporal accuracy that is observed, the adaptation process may be activated.

Temporal consistency may be calculated as the amount of displacement between two semantic maps obtained at time t and t−1. Alternatively, temporal consistency may be calculated by, between the older frame, using optical flow and warping to obtain a better estimate of displacement.

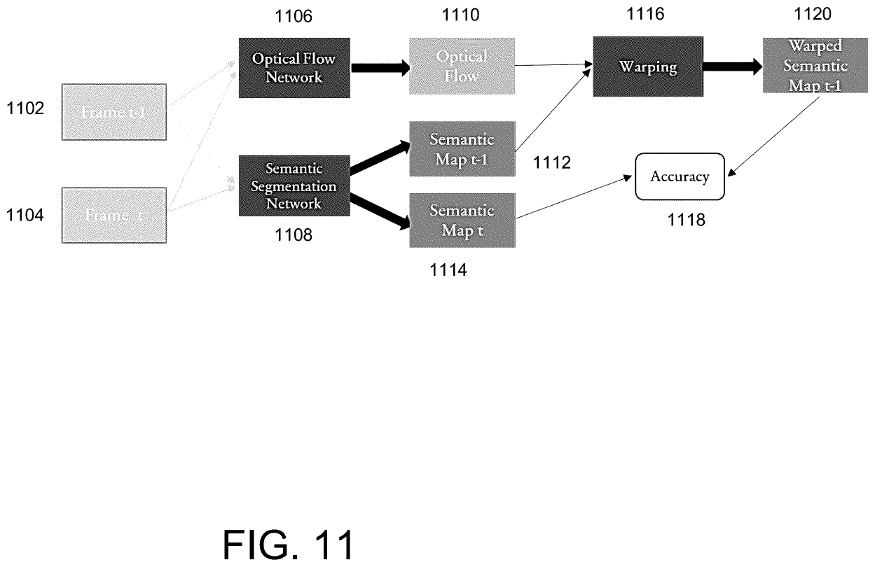

A technical effect of example embodiments of the present disclosure may be to avoid loss of performance when deactivating the adaptation process after some time. With deactivation of adaptation, an ensemble model may be used that may aggregate the result from all networks, or may only use the auxnet for low computational resource(s). Accordingly, it may make sense to stop the adaptation after some time, and start again when the performance decreases due to drastic changes in the scene. Temporal accuracy (e.g. as in FIG. 11), which is an unsupervised metric, may be used to monitor the changes in the scene. If the average of temporal accuracy over the last few dozen frames has a sudden decrease, it may be inferred that something in the environment has changed dramatically.

For computing temporal accuracy, the optical flow may be needed, which is a computationally expensive operation. In an example embodiment, the optical flow may be ignored, for example as long as the camera movement is not fast.

Referring now to FIG. 11, frame t−1 (1102) and frame t (1104) are provided to an optical flow network (1106) and a semantic segmentation network (1108). The optical flow output (1110) of the optical flow network (1106) is provided to a warping module (1116). The semantic map t−1 (1112) is output from the semantic segmentation network (1108) to a warping module (1116). The semantic map t (1114) is output from the semantic segmentation network (1108) to an accuracy module (1118). The warped semantic map t−1 (1120) is output from the warping module (1116) to the accuracy module (1118).

Example embodiments of the present disclosure, when applied to the task of semantic segmentation, resulted in the following results from online learning of a pre-trained model on ADE20K dataset tested on 200 videos (each 30 frames) of validation dataset of Cityscapes. Two pretrained models were used in this experiment, HRNET18 (10 million parameters) and HRNET48 (65 million parameters). Since the ground truth labels for the cityscape dataset don't exist, the output of a very accurate network was used as the ground truth for the Pixel Accuracy. The online learning was done using a single GPU (2070 RTX) one frame at a time.

With regard to a low complexity setup, HRNET18 was used for all GNN and ENN networks. With almost the same amount of computation, the momentum has the best performance by far, as shown in TABLEs 1-2:

TABLE 1

| | No | Aux | Momentum | Aux-Momentum |
|---|---|---|---|---|
| | Adaptation | Adapt | Adapt | Adapt |
| Pixel Accuracy | 37.5% | 38.8% | 66.9% | 37.7% |
| Temporal | 62.7% | 81.7% | 82.0% | 77.9% |
| Accuracy | | | | |

TABLE 2

| | No | Aux | Momentum | Aux-Momentum |
|---|---|---|---|---|
| | Adaptation | Adapt | Adapt | Adapt |
| Forward Pass | 10M | 20M | 20M | 30M |
| Parameters | | | | |
| Backward Pass | — | 10M | 10M | 10M |
| Parameters | | | | |

With regard to a high complexity setup, HRNET18 was used for ENN and HRNET48 was used for GNN. When we allow for more computation and a larger main net, the combination of aux and momentum adapt give us the best result, as shown in TABLEs 3-4:

TABLE 3

| | No | Aux | Momentum | Aux-Momentum |
|---|---|---|---|---|
| | Adaptation | Adapt | Adapt | Adapt |
| Pixel Accuracy | 56.8% | 61.3% | 65.9% | 67.6% |
| Temporal | 72.3% | 82.4% | 81.4% | 82.5% |
| Accuracy | | | | |

TABLE 4

| | No | Aux | Momentum | Aux-Momentum |
|---|---|---|---|---|
| | Adaptation | Adapt | Adapt | Adapt |
| Forward Pass | 65M | 75M | 20M | 85M |
| Parameters | | | | |
| Backward Pass | — | 10M | 10M | 10M |
| Parameters | | | | |

Example embodiments of the present disclosure may be implemented within the Vetrui AISA project.

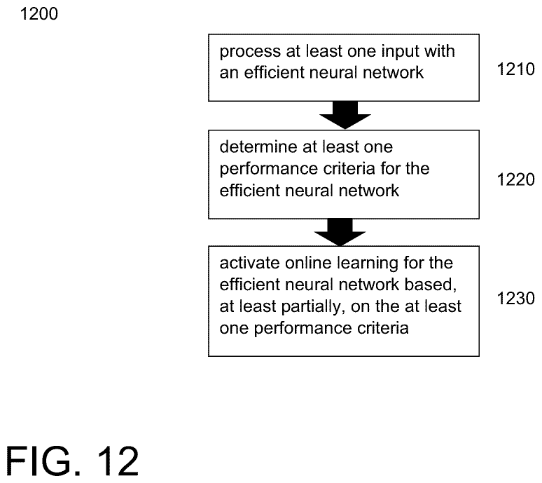

FIG. 12 illustrates the potential steps of an example method 1200. The example method 1200 may include: processing at least one input with an efficient neural network, 1210; determining at least one performance criteria for the efficient neural network, 1220; and activating online learning for the efficient neural network based, at least partially, on the at least one performance criteria, 1230. The example method 1200 may be performed, for example, with a UE, a device comprising or working with a NN, etc.

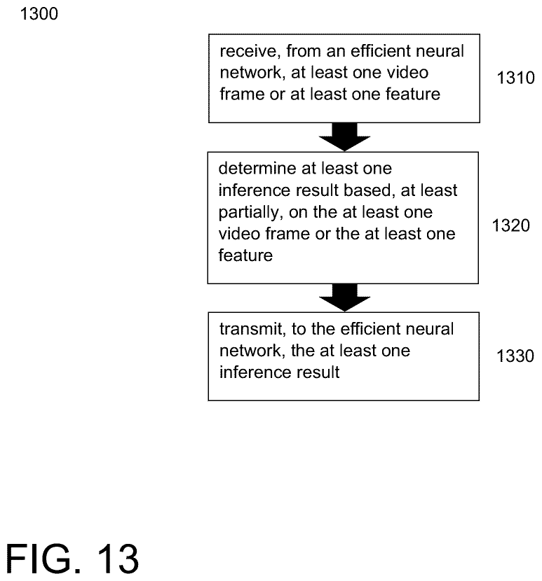

FIG. 13 illustrates the potential steps of an example method 1300. The example method 1300 may include: receiving, from an efficient neural network, at least one video frame or at least one feature, 1310; determining at least one inference result based, at least partially, on the at least one video frame or the at least one feature, 1320; and transmitting, to the efficient neural network, the at least one inference result, 1330. The example method 1300 may be performed, for example, with a server, cloud server, network entity, etc.

In accordance with one example embodiment, an apparatus may comprise: at least one processor; and at least one memory storing instructions that, when executed by the at least one processor, cause the apparatus at least to: process at least one input with an efficient neural network; determine at least one performance criteria for the efficient neural network; and activate online learning for the efficient neural network based, at least partially, on the at least one performance criteria.

The at least one performance criteria may comprise a temporal consistency criteria.

The online learning may be activated in response to the temporal consistency criteria decreasing by a threshold amount during a time period in comparison to an average observed temporal consistency criteria.

Processing the at least one input with the efficient neural network may comprise the example apparatus being further configured to: perform semantic segmentation of the at least one input, wherein the at least one input may comprise at least one video frame.

The online learning may be continually activated while at least one of the at least one performance criteria for the efficient neural network is below a threshold value.

The example apparatus may be further configured to: deactivate the online learning after a predefined period.

Activating the online learning for the efficient neural network may comprise the example apparatus being further configured to: provide, to a server, one of: the at least one input, or at least one feature of the at least one input; save locally a copy of the one of the at least one input or the at least one feature; receive, from the server, at least one inference result with respect to the one of the at least one input or the at least one feature; and retrain the efficient neural network based on the at least one inference result.

Activating the online learning for the efficient neural network may comprise the example apparatus being further configured to: provide, to a server, one of: the at least one input, or at least one feature of the at least one input; and receive, from the server, a weight update for the efficient neural network.

Activating the online learning for the efficient neural network may comprise the example apparatus being further configured to: update a generic neural network using weights from the efficient neural network, wherein the efficient neural network may comprise a momentum network, wherein the generic neural network and the efficient neural network may share a same architecture, wherein the generic neural network and the efficient neural network may comprise neural networks that are configured to be updated.

Processing the at least one input with the efficient neural network may comprise the example apparatus being further configured to: process the at least one input with a frozen main neural network; and process the at least one input with an auxiliary neural network, wherein the generic neural network and the efficient neural network may comprise neural networks that are configured to be updated.

The frozen main neural network may comprise a generic neural network, wherein the auxiliary neural network may comprise an efficient neural network, wherein the efficient neural network may comprise a momentum network.

The frozen main neural network and the auxiliary neural network may comprise a generic neural network, wherein the efficient neural network may comprise a momentum network.

In accordance with one aspect, an example method may be provided comprising: processing, with a user equipment, at least one input with an efficient neural network; determining at least one performance criteria for the efficient neural network; and activating online learning for the efficient neural network based, at least partially, on the at least one performance criteria.

The at least one performance criteria may comprise a temporal consistency criteria.

The online learning may be activated in response to the temporal consistency criteria decreasing by a threshold amount during a time period in comparison to an average observed temporal consistency criteria.

The processing of the at least one input with the efficient neural network may comprise: performing semantic segmentation of the at least one input, wherein the at least one input may comprises at least one video frame.

The online learning may be continually activated while at least one of the at least one performance criteria for the efficient neural network is below a threshold value.

The example method may further comprise: deactivating the online learning after a predefined period.

The activating of the online learning for the efficient neural network may comprise: providing, to a server, one of: the at least one input, or at least one feature of the at least one input; saving locally a copy of the one of the at least one input or the at least one feature; receiving, from the server, at least one inference result with respect to the one of the at least one input or the at least one feature; and retraining the efficient neural network based on the at least one inference result.

The activating of the online learning for the efficient neural network may comprise: providing, to a server, one of: the at least one input, or at least one feature of the at least one input; and receiving, from the server, a weight update for the efficient neural network.

The activating of the online learning for the efficient neural network may comprise: updating a generic neural network using weights from the efficient neural network, wherein the efficient neural network may comprise a momentum network, wherein the generic neural network and the efficient neural network may share a same architecture, wherein the generic neural network and the efficient neural network may comprise neural networks that are configured to be updated.

The processing of the at least one input with the efficient neural network may comprise: processing the at least one input with a frozen main neural network; and processing the at least one input with an auxiliary neural network, wherein the generic neural network and the efficient neural network may comprise neural networks that are configured to be updated.

The frozen main neural network may comprise a generic neural network, wherein the auxiliary neural network may comprise an efficient neural network, wherein the efficient neural network may comprise a momentum network.

The frozen main neural network and the auxiliary neural network may comprise a generic neural network, wherein the efficient neural network may comprise a momentum network.

In accordance with one example embodiment, an apparatus may comprise: circuitry configured to perform: processing, with a user equipment, at least one input with an efficient neural network; circuitry configured to perform: determining at least one performance criteria for the efficient neural network; and circuitry configured to perform: activating online learning for the efficient neural network based, at least partially, on the at least one performance criteria.

In accordance with one example embodiment, an apparatus may comprise: processing circuitry; memory circuitry including computer program code, the memory circuitry and the computer program code configured to, with the processing circuitry, enable the apparatus to: process at least one input with an efficient neural network; determine at least one performance criteria for the efficient neural network; and activate online learning for the efficient neural network based, at least partially, on the at least one performance criteria.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: processing at least one input with an efficient neural network; determining at least one performance criteria for the efficient neural network; and activating online learning for the efficient neural network based, at least partially, on the at least one performance criteria.

The at least one performance criteria may comprise a temporal consistency criteria.

The online learning may be activated in response to the temporal consistency criteria decreasing by a threshold amount during a time period in comparison to an average observed temporal consistency criteria.

The means configured to perform processing the at least one input with the efficient neural network may comprise means configured to perform: semantic segmentation of the at least one input, wherein the at least one input may comprise at least one video frame.

The online learning may be continually activated while at least one of the at least one performance criteria for the efficient neural network is below a threshold value.

The means may be further configured to perform: deactivating the online learning after a predefined period.

The means configured to perform activating the online learning for the efficient neural network may comprise means configured to perform: providing, to a server, one of: the at least one input, or at least one feature of the at least one input; saving locally a copy of the one of the at least one input or the at least one feature; receiving, from the server, at least one inference result with respect to the one of the at least one input or the at least one feature; and retraining the efficient neural network based on the at least one inference result.

The means configured to perform activating the online learning for the efficient neural network may comprise means configured to perform: providing, to a server, one of: the at least one input, or at least one feature of the at least one input; and receiving, from the server, a weight update for the efficient neural network.

The means configured to perform activating the online learning for the efficient neural network may comprise means configured to perform: updating a generic neural network using weights from the efficient neural network, wherein the efficient neural network may comprise a momentum network, wherein the generic neural network and the efficient neural network may share a same architecture, wherein the generic neural network and the efficient neural network may comprise neural networks that are configured to be updated.

The means configured to perform processing the at least one input with the efficient neural network may comprise means configured to perform: processing the at least one input with a frozen main neural network; and processing the at least one input with an auxiliary neural network, wherein the generic neural network and the efficient neural network may comprise neural networks that are configured to be updated.

The frozen main neural network may comprise a generic neural network, wherein the auxiliary neural network may comprise an efficient neural network, wherein the efficient neural network may comprise a momentum network.

The frozen main neural network and the auxiliary neural network may comprise a generic neural network, wherein the efficient neural network may comprise a momentum network.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: process at least one input with an efficient neural network; determine at least one performance criteria for the efficient neural network; and activate online learning for the efficient neural network based, at least partially, on the at least one performance criteria.

In accordance with one example embodiment, a non-transitory computer-readable medium comprising program instructions stored thereon for performing at least the following: processing at least one input with an efficient neural network; determining at least one performance criteria for the efficient neural network; and activating online learning for the efficient neural network based, at least partially, on the at least one performance criteria.

In accordance with another example embodiment, a non-transitory program storage device readable by a machine may be provided, tangibly embodying instructions executable by the machine for performing operations, the operations comprising: processing at least one input with an efficient neural network; determining at least one performance criteria for the efficient neural network; and activating online learning for the efficient neural network based, at least partially, on the at least one performance criteria.

In accordance with another example embodiment, a non-transitory computer-readable medium comprising instructions that, when executed by an apparatus, cause the apparatus to perform at least the following: processing at least one input with an efficient neural network; determining at least one performance criteria for the efficient neural network; and activating online learning for the efficient neural network based, at least partially, on the at least one performance criteria.

A computer implemented system comprising: at least one processor and at least one non-transitory memory storing instructions that, when executed by the at least one processor, cause the system at least to perform: processing at least one input with an efficient neural network; determining at least one performance criteria for the efficient neural network; and activating online learning for the efficient neural network based, at least partially, on the at least one performance criteria.

A computer implemented system comprising: means for processing at least one input with an efficient neural network; means for determining at least one performance criteria for the efficient neural network; and means for activating online learning for the efficient neural network based, at least partially, on the at least one performance criteria.

In accordance with one example embodiment, an apparatus may comprise: at least one processor; and at least one memory storing instructions that, when executed by the at least one processor, cause the apparatus at least to: receive, from an efficient neural network, at least one video frame or at least one feature; determine at least one inference result based, at least partially, on the at least one video frame or the at least one feature; and transmit, to the efficient neural network, the at least one inference result.

The at least one inference result may be determined with a generic neural network.

The example apparatus may comprise a server.

The example apparatus may be further configured to: train the efficient neural network.

In accordance with one aspect, an example method may be provided comprising: receiving, from an efficient neural network, at least one video frame or at least one feature; determining at least one inference result based, at least partially, on the at least one video frame or the at least one feature; and transmitting, to the efficient neural network, the at least one inference result.

The at least one inference result may be determined with a generic neural network.

The example method may further comprise: training the efficient neural network.

In accordance with one example embodiment, an apparatus may comprise: circuitry configured to perform: receiving, from an efficient neural network, at least one video frame or at least one feature; circuitry configured to perform: determining at least one inference result based, at least partially, on the at least one video frame or the at least one feature; and circuitry configured to perform: transmitting, to the efficient neural network, the at least one inference result.

In accordance with one example embodiment, an apparatus may comprise: processing circuitry; memory circuitry including computer program code, the memory circuitry and the computer program code configured to, with the processing circuitry, enable the apparatus to: receive, from an efficient neural network, at least one video frame or at least one feature; determine at least one inference result based, at least partially, on the at least one video frame or the at least one feature; and transmit, to the efficient neural network, the at least one inference result.

In accordance with one example embodiment, an apparatus may comprise means for performing: receiving, from an efficient neural network, at least one video frame or at least one feature; determining at least one inference result based, at least partially, on the at least one video frame or the at least one feature; and transmitting, to the efficient neural network, the at least one inference result.

The at least one inference result may be determined with a generic neural network.

The apparatus may comprise a server.

The means may be further configured to perform: training the efficient neural network.

In accordance with one example embodiment, a non-transitory computer-readable medium comprising instructions stored thereon which, when executed with at least one processor, cause the at least one processor to: cause receiving, from an efficient neural network, of at least one video frame or at least one feature; determine at least one inference result based, at least partially, on the at least one video frame or the at least one feature; and cause transmitting, to the efficient neural network, of the at least one inference result.

In accordance with one example embodiment, a non-transitory computer-readable medium comprising program instructions stored thereon for performing at least the following: causing receiving, from an efficient neural network, of at least one video frame or at least one feature; determining at least one inference result based, at least partially, on the at least one video frame or the at least one feature; and causing transmitting, to the efficient neural network, of the at least one inference result.

In accordance with another example embodiment, a non-transitory program storage device readable by a machine may be provided, tangibly embodying instructions executable by the machine for performing operations, the operations comprising: causing receiving, from an efficient neural network, of at least one video frame or at least one feature; determining at least one inference result based, at least partially, on the at least one video frame or the at least one feature; and causing transmitting, to the efficient neural network, of the at least one inference result.

In accordance with another example embodiment, a non-transitory computer-readable medium comprising instructions that, when executed by an apparatus, cause the apparatus to perform at least the following: causing receiving, from an efficient neural network, of at least one video frame or at least one feature; determining at least one inference result based, at least partially, on the at least one video frame or the at least one feature; and causing transmitting, to the efficient neural network, of the at least one inference result.

A computer implemented system comprising: at least one processor and at least one non-transitory memory storing instructions that, when executed by the at least one processor, cause the system at least to perform: causing receiving, from an efficient neural network, of at least one video frame or at least one feature; determining at least one inference result based, at least partially, on the at least one video frame or the at least one feature; and causing transmitting, to the efficient neural network, of the at least one inference result.

A computer implemented system comprising: means for causing receiving, from an efficient neural network, of at least one video frame or at least one feature; means for determining at least one inference result based, at least partially, on the at least one video frame or the at least one feature; and means for causing transmitting, to the efficient neural network, of the at least one inference result.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

What is claimed is:

1. An apparatus comprising:
at least one processor; and
at least one non-transitory memory storing instructions that, when executed by the at least one processor, cause the apparatus at least to:
process at least one input with an efficient neural network;
determine at least one performance criteria for the efficient neural network; and
activate online learning for the efficient neural network based, at least partially, on the at least one performance criteria.

2. The apparatus of claim 1, wherein the at least one performance criteria comprises a temporal consistency criteria.

3. The apparatus of claim 2, wherein the online learning is activated in response to the temporal consistency criteria decreasing by a threshold amount during a time period in comparison to an average observed temporal consistency criteria.

4. The apparatus of claim 1, wherein processing the at least one input with the efficient neural network comprises the at least one memory stores instructions that, when executed by the at least one processor, cause the apparatus to:
perform semantic segmentation of the at least one input, wherein the at least one input comprises at least one video frame.

5. The apparatus of claim 1, wherein the online learning is continually activated while at least one of the at least one performance criteria for the efficient neural network is below a threshold value.

6. The apparatus of claim 1, wherein the at least one memory stores instructions that, when executed by the at least one processor, cause the apparatus to:
deactivate the online learning after a predefined period.

7. The apparatus of claim 1, wherein activating the online learning for the efficient neural network comprises the at least one memory stores instructions that, when executed by the at least one processor, cause the apparatus to:
provide, to a server, one of: the at least one input, or at least one feature of the at least one input;
save locally a copy of the one of the at least one input or the at least one feature;
receive, from the server, at least one inference result with respect to the one of the at least one input or the at least one feature; and
retrain the efficient neural network based on the at least one inference result.

8. The apparatus of claim 1, wherein activating the online learning for the efficient neural network comprises the at least one memory stores instructions that, when executed by the at least one processor, cause the apparatus to:
provide, to a server, one of: the at least one input, or at least one feature of the at least one input; and
receive, from the server, a weight update for the efficient neural network.

9. The apparatus of claim 1, wherein processing the at least one input with the efficient neural network comprises the at least one memory stores instructions that, when executed by the at least one processor, cause the apparatus to:
process the at least one input with a frozen main neural network; and
process the at least one input with an auxiliary neural network.

10. A method comprising:
processing, with a user equipment, at least one input with an efficient neural network;
determining at least one performance criteria for the efficient neural network; and
activating online learning for the efficient neural network based, at least partially, on the at least one performance criteria.

11. The method of claim 10, wherein the at least one performance criteria comprises a temporal consistency criteria.

12. The method of claim 11, wherein the online learning is activated in response to the temporal consistency criteria decreasing by a threshold amount during a time period in comparison to an average observed temporal consistency criteria.

13. The method of claim 10, wherein the processing of the at least one input with the efficient neural network comprises:
performing semantic segmentation of the at least one input, wherein the at least one input comprises at least one video frame.

14. The method of claim 10, wherein the activating of the online learning for the efficient neural network comprises:
providing, to a server, one of: the at least one input, or at least one feature of the at least one input;
saving locally a copy of the one of the at least one input or the at least one feature;
receiving, from the server, at least one inference result with respect to the one of the at least one input or the at least one feature; and
retraining the efficient neural network based on the at least one inference result.

15. The method of claim 10, wherein the activating of the online learning for the efficient neural network comprises:
providing, to a server, one of: the at least one input, or at least one feature of the at least one input; and
receiving, from the server, a weight update for the efficient neural network.

16. The method of claim 10, wherein the processing of the at least one input with the efficient neural network comprises:
processing the at least one input with a frozen main neural network; and
processing the at least one input with an auxiliary neural network.

17. An apparatus comprising:
at least one processor; and
at least one non-transitory memory storing instructions that, when executed by the at least one processor, cause the apparatus at least to:
receive, from an efficient neural network, at least one video frame or at least one feature;
determine at least one inference result based, at least partially, on the at least one video frame or the at least one feature; and
transmit, to the efficient neural network, the at least one inference result.

18. The apparatus of claim 17, wherein the at least one inference result is determined with a generic neural network.

19. The apparatus of claim 17, wherein the apparatus comprises a server.

20. The apparatus of claim 17, wherein the at least one memory stores instructions that, when executed by the at least one processor, cause the apparatus to:
train the efficient neural network.
